(19) United States
(12) Patent Application Publication
(10) Pub. No.: US 2015/0200978 A1
(43) Pub. Date: Jul. 16, 2015

(54) Meeting Conflict Indicator

(71) Applicant: Cisco Technology, Inc., San Jose, CA (US)

(72) Inventors: David Putterman, Cambridge, MA (US); Brian Glanville, Shirley, MA (US); Konstas Yannakopoulos, Bolton, MA (US); Dhiren Patel, Berlin, MA (US)

(73) Assignee: Cisco Technology, Inc., San Jose, CA (US)

(21) Appl. No.: 14/153,624

(22) Filed: Jan. 13, 2014

(51) Int. Cl. H04L 29/06; G06Q 10/02; G06Q 10/06

(52) U.S. Cl. CPC H04L 65/403; G06Q 10/06311; G06Q 10/02

(57) ABSTRACT

Presented herein are techniques for obtaining, for each of a plurality of participants of an online conference session, scheduling information proximate in time to or overlapping in time with a scheduled occurrence of the conference session. Based upon the obtained scheduling information for each participant, a determination is made as to whether the participant has a scheduled activity prior to, during or after the occurrence of the conference session. One or more status indicators that indicate the availability of one or more participants of the plurality of participants relative to the occurrence of the conference session are displayed to the plurality of participants in a display window during the conference session.

### TECHNICAL FIELD

The present disclosure relates to online meeting/conference sessions.

### BACKGROUND

Online conference sessions provide a convenient way for participants in different geographical locations to communicate with one another. For example, using an online conference service, a first participant in a first location and a second participant in a second location may have the capability to communicate with one another using both audio and video communication, and be able to share documents, allowing each participant to view the same content at the same time. Frequently, one or more participants may need to arrive late or leave early due to adjacent or overlapping meetings, activities, or other commitments. Accordingly, online conference sessions may need to be extended or discussion topics rearranged in order to accommodate a participant's schedule.

### BRIEF DESCRIPTION OF THE DRAWINGS

FIG. 1 is a block diagram of a system in which an online conference session may be supported according to the techniques disclosed herein.

FIG. 2A is an illustration of an example display of calendar information of online conference session participants, according to the techniques disclosed herein.

FIGS. 3A and 3B illustrate ladder sequence diagrams, depicting operations for obtaining and processing calendar information according to the techniques disclosed herein.

FIG. 4A illustrates examples of different types of status indicators that may be displayed according to the techniques disclosed herein.

FIG. 4B is an illustration of an example graphical user interface displaying status indicators pertaining to scheduling information of meeting participants, according to the techniques disclosed herein.

FIG. 5 is a flowchart generally depicting operations according to the techniques disclosed herein.

FIG. 6 is an example block diagram of an apparatus configured to obtain and generate participant status information according to the techniques disclosed herein.

### DESCRIPTION OF EXAMPLE EMBODIMENTS

### Overview

Presented herein are techniques for obtaining, for each of a plurality of participants of an online conference session, scheduling information proximate in time to or overlapping in time with a scheduled occurrence of the conference session. Based upon the obtained scheduling information for each participant, a determination is made as to whether the participant has a scheduled activity prior to, during or after the occurrence of the conference session. One or more status indicators that indicate the availability of one or more participants of the plurality of participants relative to the occurrence of the conference session are displayed in a display window to each of the participants during the conference session.

### Example Embodiments

When in an online conference meeting/session with remote participants, participants frequently may need to leave early or arrive late due to immediately adjacent (previous or subsequent) or overlapping meetings relative to the scheduled meeting. When such a scheduling conflict occurs, participants usually announce their departure during the meeting, which can be disruptive to the flow of the meeting. Additionally, at the start of a meeting, participants are frequently asked to wait until all participants have joined the meeting, as it may be unclear as to whether a scheduling conflict has occurred for a participant that has yet to join the meeting.

Additionally, upon approaching the end of a meeting, a moderator (host) or presenter may determine that additional time is needed to discuss one or more planned agenda items for the meeting. Frequently, a moderator or presenter may ask for additional time, which again, can be disruptive to the flow of the meeting.

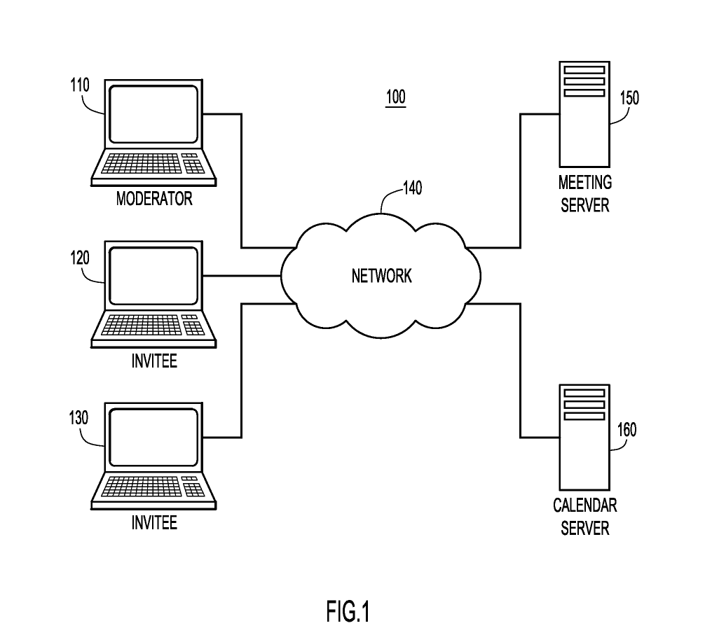

According to the techniques presented herein, an indicator may be displayed next to each meeting participant's name to indicate whether that participant has another meeting before the current meeting, after the current meeting or during the current meeting. These techniques will be described more fully with reference to FIGS. 1-6 and the following description provided below.

FIG. 1 is a block diagram of an online meeting system 100 including one or more user devices 110, 120 and 130 capable of communicating, via a network 140, with one or more servers, e.g., a meeting server 150 and a calendar server 160. The user devices may be a computer terminal, Smartphone, tablet computer, or any other device having a display screen and capable of supporting a communication session. Meeting server 150 is configured to host the online communication session. Calendar server 160, shown in FIG. 1 as a single server for simplicity, may maintain calendar information for one or more participants of the online communication session.

A moderator device 110 may send a request to meeting server 150 over the network 140 to schedule an online communication session with devices 120 and 130. Meeting server 150 receives and accepts requests from the moderator device 110, or other device having sufficient administrative privileges, to schedule, and when the scheduled time occurs, to establish and maintain an online conference session at the designated time. Meeting server 150 also synchronizes video and/or audio content of the online conference session between moderator device 110 and each participant at user devices 120 and 130.

Participants may have varying degrees of administrative privileges, e.g., a moderator may have full administrative privileges, while participants may have limited or no privileges in terms of making changes to parameters associated with a meeting. In addition, under certain circumstances, a participant may be granted elevated privileges, providing the participant with the capability to perform part or all of the functionality performed by the moderator. It should be understood that a moderator may have such privileges regardless of the physical device he/she uses to schedule and host a meeting, and likewise, participants have their associated privileges regardless of the particular device they use to participate in an online meeting.

According to the techniques presented herein, administrative privileges would include the ability to alter the start time and/or the end time of a scheduled online conference session, while the conference is occurring or immediately preceding the start of the scheduled conference. Privileges to extend the meeting or change the start time and/or end time of the meeting may be granted to the moderator, organizer or other participant of the meeting. A moderator may extend such privileges to a meeting participant at any time during the occurrence of the online conference session.

Network 140 may include a local area network, wide area network (e.g., the Internet), wireless or hybrid network, that is capable of forwarding/routing messages between the moderator device 110, the one or more participant/user devices 120 and 130, the meeting server 150 and the calendar server 160. Additional features of the online conference session are described in additional detail below.

It is also understood that meeting server 150 may request calendar information from a plurality of calendar servers of different types. For example, meeting server 150 may request calendar information from calendars associated with email servers, online calendars, calendars maintained on mobile handheld devices, calendars associated with management software, or any such system containing scheduling information.

Further, system 100 is not intended to be limiting with regard to the particular communication session shown. The techniques presented are applicable to a virtually unlimited number of servers, e.g., a plurality of calendar servers, as well as a multitude of network configurations and a plurality of devices.

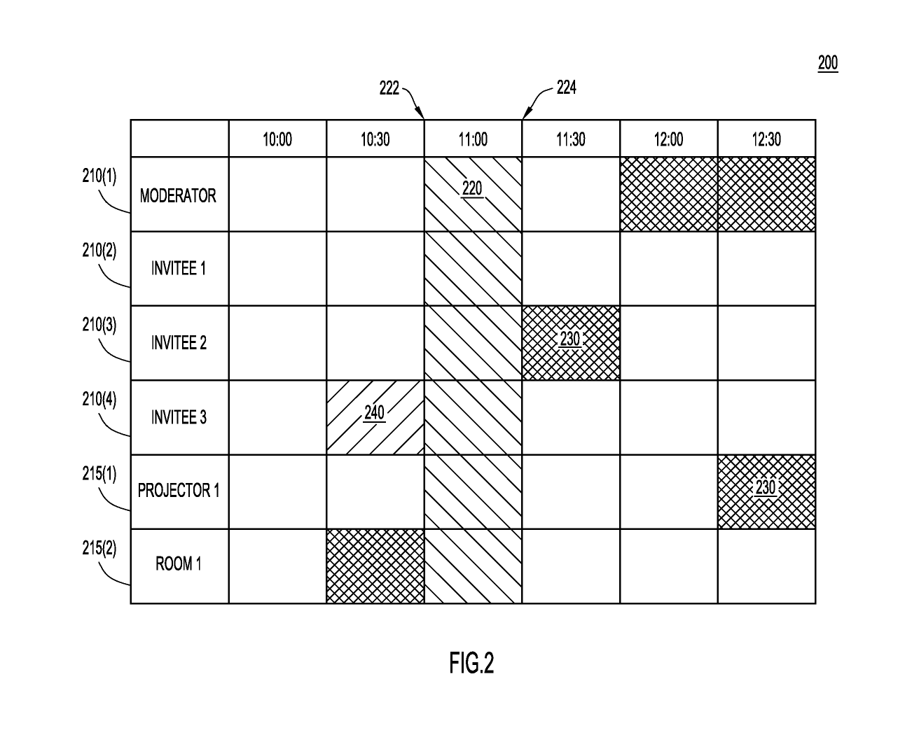

Reference is now made to FIG. 2. FIG. 2 shows an illustration of portions of example calendar information 200 for participants 210(1)-210(4) (moderator and invitees 1, 2 and 3) of an online conference session 220 and resources 215(1) and 215(2) that have been reserved in conjunction with the conference session 220. In this example, the online conference session 220 is scheduled to start at a start time 222 corresponding to 11:00 a.m. and to end at an end time 224 corresponding to 11:30 a.m. The schedules of each participant of the conference session and associated resource before, during and after the conference session 220 are shown. As discussed previously, this type of calendar information may be requested from calendar servers or any equivalent database, application or resource that contains scheduling information for a participant.

Calendar information for each participant is obtained according to the techniques disclosed herein. Scheduled meetings, other than the online conference session 220, are shown by the crosshatched blocks at reference numeral 230. A time period in which a schedule is unknown is shown at reference numeral 240, which may occur, for example, when the calendar information could not be obtained, or if another meeting was tentatively scheduled but not confirmed.

In this example, moderator 210(1) has another meeting scheduled, beginning at noon. Invitee 1 does not have any meetings scheduled before or after the conference session, and accordingly, the corresponding schedule is clear. Invitee 2 has another meeting scheduled immediately after the scheduled conference session 220, beginning at 11:30 a.m., and therefore may not be able to attend the conference session, if the session is extended beyond 11:30 a.m. The schedule of Invitee 3 could not be determined immediately prior to the conference session, and is shown as a hatched block 240. Additionally, commonly reserved resources 215(1) and 215(2) used in conjunction with the conference session 220 are also shown. For example, the schedule for projector 215(1) shows that it is available immediately before and after the meeting, but is reserved beginning at 12:30 p.m. In contrast, room 1 is reserved for the conference session, has been reserved at 10:30 a.m. for another meeting prior to the conference session, and therefore, would not be available prior to the current start time for conference session 220.

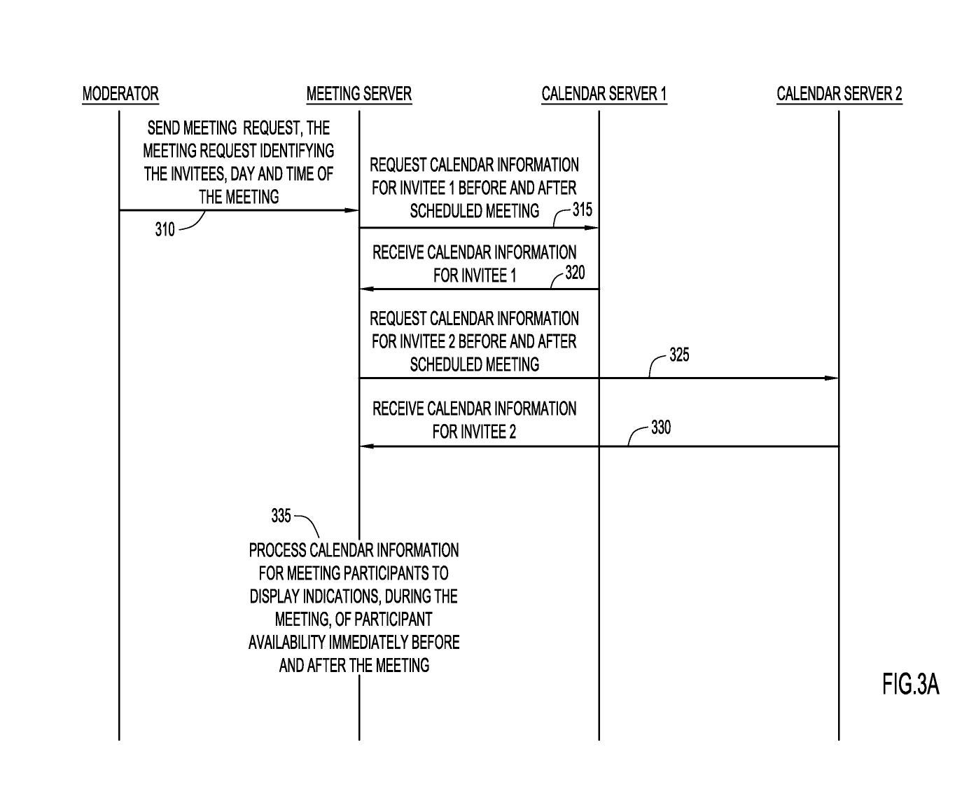

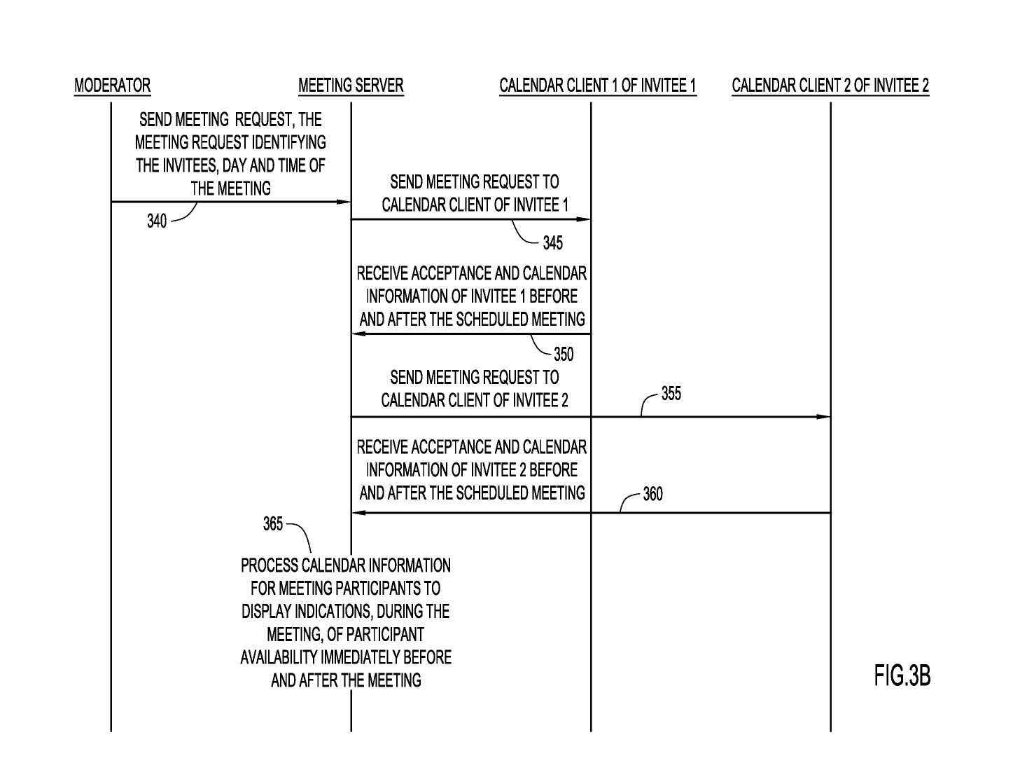

By obtaining scheduling information, e.g., calendar information, prior to, during, and after the meeting, for each of the meeting participants and/or any resources associated with the scheduled meeting, the scheduling information can be analyzed, as described further below with regard to FIGS. 3-5, to improve meeting efficiency and adjust various meeting parameters, such as the start time and end time of an online conference session as well as the ordering of the meeting agenda.

For example, if a moderator or participant determines that additional time for the conference session is needed, participant schedules can be evaluated to determine if a conflict occurs after the current end point of the meeting. If no conflicts occur among any of the participants, the meeting may be extended. If one or more participants have a conflict, but only need to be present for a subset of meeting topics, then the moderator may decide to prioritize topics such that the subset of topics relevant to the one or more participants having a scheduling conflict are presented for discussion first. Additionally, scheduling information may be available immediately prior to the start time of the meeting. A moderator may have the option of changing the start time, provided that participants do not have a scheduling conflict prior to the start time of the meeting. Furthermore, the duration of the time window immediately before and immediately after the scheduled meeting for which conflicts should be considered may be configurable. For example, one-half hour time slots before and after the scheduled meeting may be deemed appropriate, or for other situations, one hour time slots before and after the scheduled meeting may be considered.

FIGS. 3A and 3B each show a ladder sequence diagram according to examples of the techniques presented herein. It is noted that, in both examples, calendar information before, during (not shown for simplicity), and after the scheduled meeting may be received by the meeting server. FIG. 3A shows an example in which calendar information for meeting participants and resources is not maintained by a single calendar server. In this example, different calendar servers may be configured to establish a trusted relationship with the meeting server 150, allowing the meeting server 150 to access calendar information of all the participants and resources from other sources such as Google, ICal, Exchange, etc.

At operation 310, a meeting request is sent from a moderator to a meeting server, wherein the meeting request identifies the invitees, day and time of the meeting. At operation 315, calendar information for invitee 1 before, during and after the scheduled meeting is requested from calendar server 1. It is noted that this request may be sent to any of a multitude of calendar servers, each of which stores calendar information for invitee 1. At operation 320, calendar information is received at the meeting server for invitee 1. At operation 325, calendar information for invitee 2 before, during and after the scheduled meeting is requested from calendar server 2. Again, it is noted that this request may be sent to any of a multitude of calendar servers, each of which stores calendar information for invitee 2. At operation 330, calendar information is received at the meeting server for invitee 2. At operation 335, calendar information is processed for the meeting participants in order to display indications, during the meeting, of participant availability immediately before, during and after the meeting. In other aspects, such scheduling information may be available and presented to any one or more of the meeting participants for a designated time period before the meeting begins. The meeting server may periodically send an inquiry to the calendar servers to receive updated calendar information of meeting participants up to the actual occurrence of the scheduled meeting.

FIG. 3B describes another option for gathering scheduling information across different calendar servers. In this example, calendar information is obtained directly from clients, e.g., including mobile applications, plugins, etc., which have access to a participant's calendar and may be able to provide information about adjacent or overlapping meetings at the time a meeting invitation from a meeting server is accepted. At operation 340, a meeting request is sent to a meeting server, wherein the meeting request identifies the invitees as well as a day and time of the meeting. At operation 345, a meeting request is sent to a calendar client 1 of invitee 1. At operation 350, notification that the calendar client of invitee 1 has accepted the meeting is received, together with calendar information for invitee 1 before, during and after the meeting. At operation 355, a meeting request is sent to a calendar client 2 of invitee 2. At operation 360, notification that the calendar client of invitee 2 has accepted the meeting is received, together with calendar information for invitee 2 before, during and after the meeting. At operation 365, calendar information is processed for meeting participants in order to display one or more indications, during the meeting, of participant availability immediately before, during and after the meeting. Such scheduling information may also be available for a designated time period before the meeting begins.

If scheduling information is updated after a meeting request has been accepted, then the calendar clients may push updates or provide the information to meeting server 150 at the time the update occurs or once a participant joins the meeting.

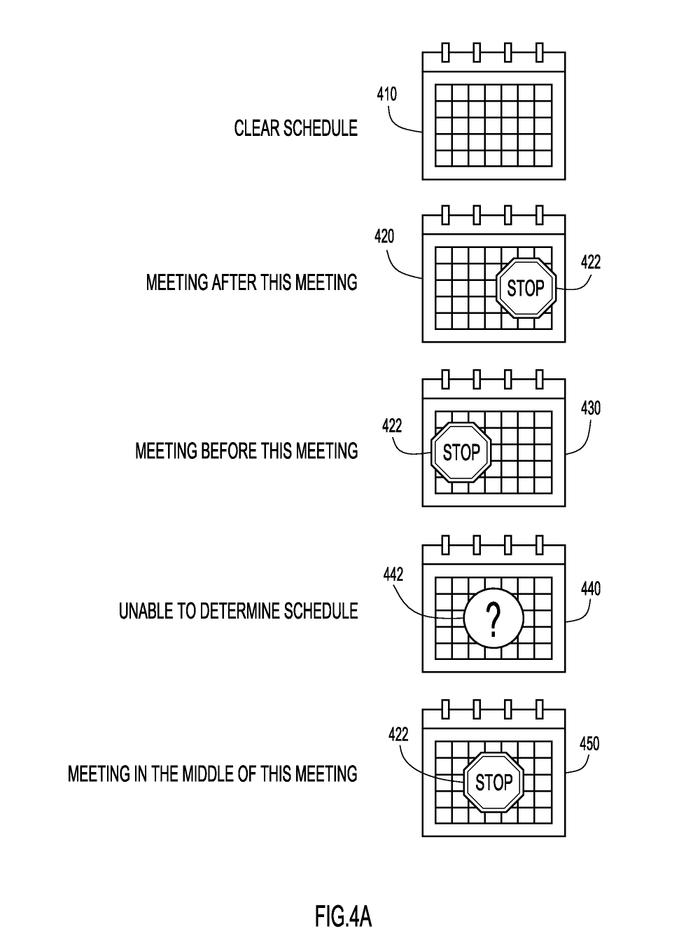

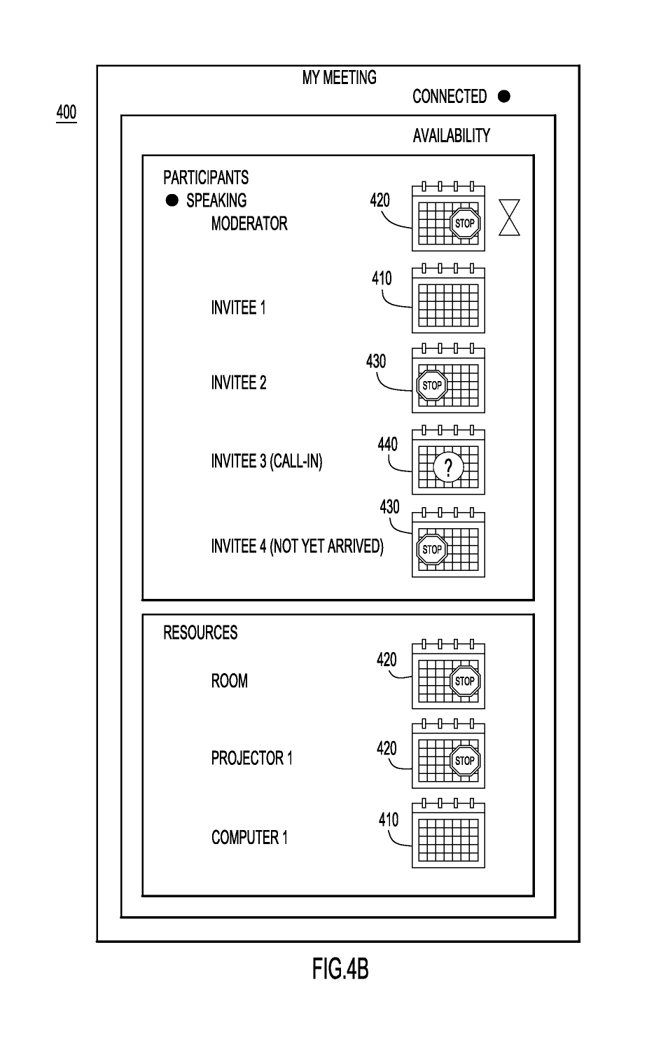

Reference is now made to FIG. 4A, which shows examples of various types of status indicators, shown as graphical elements. In these examples, a stop sign element or a question mark element has been overlaid onto a calendar graphic (as appropriate) to create a graphical element indicating the nature of the conflict (should a conflict exist). The various status indicators shown in FIG. 4A may indicate the occurrence of a conflict. Some graphical elements, e.g., graphical element 410 (described below), indicate that a conflict is not present. Other graphical elements, e.g., graphical elements 420, 430 and 450 (also described below), indicate the occurrence of a conflict, and therefore, may also be referred to in the specification as a conflict indicator.

Graphical element 410 includes a calendar graphic that is clear of any other icon and is intended to indicate that a participant's calendar is clear immediately before, during and after the scheduled meeting. Graphical element 420 has a “stop” sign element 422 to the right edge of the calendar graphic and this indicates that a participant has an event scheduled immediately after the scheduled meeting. Graphical element 430 is similar to graphical element 420 but has the “stop” sign element 422 to the left edge of the calendar graphic, and this indicates that a participant has a conflict immediately prior to the meeting. Graphical element 440 is used when a schedule for a participant cannot be obtained, which is a calendar graphic along with a “question mark” or other designated element 442. Graphical element 450, having the “stop” sign element in the middle of the calendar graphic, is used to indicate that a participant has a conflict during the meeting.

FIG. 4B shows an example of a graphical user interface display screen according to the techniques presented herein, and using the graphical elements shown in FIG. 4A. In this example, each participant of the online conference session, along with each reserved resource, is displayed, along with a status indicator, shown as a graphical element that indicates availability immediately prior to the meeting, during the meeting, and immediately after the meeting. Although not shown in this example, multiple types of status indicators may be displayed if a participant has multiple conflicts relative to a scheduled meeting. For example, a participant may have a conflict both before and after a scheduled meeting, and therefore, a graphical element with a “stop” sign element to the left of the scheduled meeting and a “stop” sign element to the right of the scheduled meeting may be overlaid onto a calendar graphic to represent determined conflicts. Many other such combinations are possible, and are understood to fall within the scope of the techniques disclosed herein.

In this example, a moderator has a conflict following the meeting. Thus, the graphical element/icon 420 is displayed to indicate that the moderator has a meeting immediately after the scheduled meeting. Invitee 1 does not have any conflicts immediately prior to or after the meeting. The graphical element/icon 410 is therefore displayed indicating Invitee 1 has no conflicts immediately preceding and after the meeting. Invitee 2 has a conflict prior to the meeting and the graphical element/icon 430 is displayed. The status of Invitee 3 could not be determined during the specified time period, and therefore the graphical element/icon 440 is displayed. Additionally, status information may be presented for users that have not yet joined the conference session. For example, although Invitee 4 has not yet arrived for (joined) the meeting, calendar information corresponding to the schedule of Invitee 4 is available and the graphical element/icon 430 is displayed to indicate that Invitee 4 has another meeting immediately prior to the scheduled meeting. The techniques presented herein allow for a participant to appear in the list of participants, e.g., with a greyed-out or other graphical indicator to show that the participant has not yet arrived for the meeting.

Status information for commonly reserved resources, such as a reserved room, projector or computer is also presented. For example, graphical element 420 is displayed to indicate that room 1 and projector 1 have a conflict immediately following the conference session, but the computer is clear immediately before, during and after the meeting, and in that case, graphical element 410 is displayed.

Thus, based upon status indicators that indicate the availability of each participant and resource, for example, as shown in FIGS. 4A and 4B, a moderator or other authorized participant can determine whether to extend the duration of the conference session. If all participants and reserved resources do not have a meeting adjacent to or overlapping with the currently scheduled end time of the ongoing conference session, the moderator may extend the duration of the meeting. If necessary, the moderator may send a command to the meeting server 150 to maintain the support for the extended meeting session for a specified period of time. Upon extending the duration of the online conference session, updated scheduling information may be provided to both the participants of the current meeting, reflecting the extended meeting time, and also, to participants of one or more other meetings that are scheduled to occur immediately after the extended meeting. Normally, the meeting is extended by the participants simply continuing on with the meeting.

Additional information about a specific conflict may be obtained by placing the cursor over or selecting the conflict indicator. For example, by double-clicking on the conflict indicator for projector 1, additional information about the reservation, e.g., who has reserved the room, the start time of the reservation, etc. may be displayed.

Thus, with regard to the techniques disclosed herein, data is collected and analyzed by meeting server 150. For each conference participant, including the moderator, and associated resources, a determination is made as to whether a meeting occurs before, during or after the scheduled conference session. Based on this determination, an appropriate status is generated, and data representing the graphical presentation (as depicted in FIGS. 4A and 4B) is sent to each endpoint device 110, 120 and 130 for display on a display screen. The duration of the conference session may be extended, based upon the one or more status indicators that indicate the availability of each participant relative to the meeting.

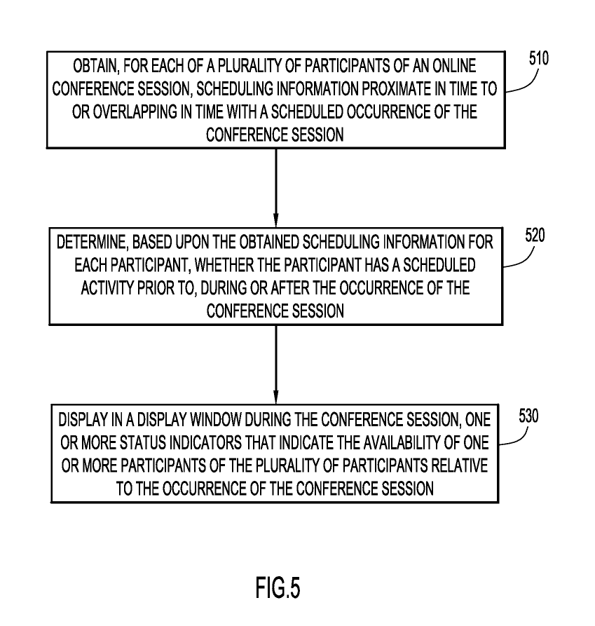

FIG. 5 shows a high-level/generalized flowchart of operations performed by meeting server 150 according to the techniques described herein. At operation 510, for each of a plurality of participants of an online conference session, scheduling information proximate in time to or overlapping in time with a scheduled occurrence of the conference session is obtained. At operation 520, based upon the obtained scheduling information for each participant, a determination is made as to whether a participant has a scheduled activity prior to, during or after the occurrence of the conference session. At operation 530, one or more status indicators that indicate the availability of one or more participants of the plurality of participants relative to the occurrence of the conference session are displayed in a display window to one or more meeting participants during the conference session. As explained above, operations 510-530 may be repeated at specified time intervals to capture changes to a participant's schedule while the conference session is occurring or prior to the beginning of the conference session to obtain up-to-date information.

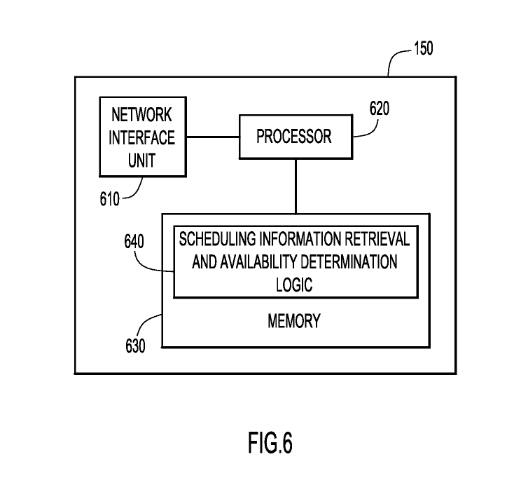

FIG. 6 illustrates an example block diagram of an apparatus, meeting server 150, configured to perform the techniques presented herein. The meeting server 150 includes a network interface unit 610, a processor 620, and a memory 630. The network interface unit 610 is configured to enable network communications over a network to send data to user devices in an online conference session (video, audio as well as overlaid graphics, e.g., the graphics shown in FIG. 4B). The network interface unit 610 also receives data (audio, video, shared document data, etc.) from the user devices.

The processor 620 may be embodied by one or more microprocessors or microcontrollers, and executes software instructions stored in memory 630 for scheduling information retrieval and availability determination logic 640 to perform the operations described above in connection with FIGS. 1-5.

Memory 630 may be embodied by one or more computer readable storage media that may comprise read only memory (ROM), random access memory (RAM), magnetic disk storage media devices, optical storage media devices, flash memory devices, electrical, optical, or other physical/tangible memory storage devices.

Thus, in general, the memory 630 may comprise one or more tangible (e.g., non-transitory) computer readable storage media (e.g., a memory device) encoded with software comprising computer executable instructions, and when the software is executed by the processor 620, the processor 620 is operable to perform the operations described herein in connection with scheduling information retrieval and availability determination logic 640. Scheduling information retrieval and availability determination logic 640, as disclosed herein, obtains calendar information for each participant, determines availability of each participant, and provides an appropriate status indicator to be displayed on each participant device.

The functions of the processor 620 may be implemented by logic encoded in one or more tangible computer readable storage media or devices (e.g., storage devices compact discs, digital video discs, flash memory drives, etc. and embedded logic such as an ASIC, digital signal processor instructions, software that is executed by a processor, etc.).

While FIG. 6 shows that the meeting server 150 may be embodied as a dedicated physical device, it should be understand that the functions of the server 150 may be embodied as software running in a data center/cloud computing system, together with numerous other software applications.

The techniques presented herein may apply to any resources that are commonly shared, and are not limited to the specific examples disclosed herein.

The techniques presented herein provide a computer-implemented method, apparatus and computer readable media of obtaining, for each of a plurality of participants of an online conference session, scheduling information proximate in time to or overlapping in time with a scheduled occurrence of the conference session; determining, based upon the obtained scheduling information for each participant, whether the participant has a scheduled activity prior to, during or after the occurrence of the conference session; and displaying in a display window during the conference session, one or more status indicators that indicate the availability of one or more participants of the plurality of participants relative to the occurrence of the conference session.

Although the apparatus, system, and computer-implemented method are illustrated and described herein as embodied in one or more specific examples, it is nevertheless not intended to be limited to the details shown, since various modifications and structural changes may be made therein without departing from the scope of the apparatus, system, and computer-implemented method and within the scope and range of equivalents of the claims. Accordingly, it is appropriate that the appended claims be construed broadly and in a manner consistent with the scope of the apparatus, system, and computer-implemented method, as set forth in the following claims.

The above description is intended by way of example only. Various modifications and structural changes may be made therein without departing from the scope of the concepts described herein and within the scope and range of equivalents of the claims.

What is claimed is:

1. A computer-implemented method comprising:
obtaining, for each of a plurality of participants of an online conference session, scheduling information proximate in time to or overlapping in time with a scheduled occurrence of the conference session;
determining, based upon the obtained scheduling information for each participant, whether the participant has a scheduled activity prior to, during or after the occurrence of the conference session; and
displaying in a display window during the conference session, one or more status indicators that indicate the availability of one or more participants of the plurality of participants relative to the occurrence of the conference session.

2. The computer-implemented method of claim 1, further comprising:
obtaining, for a requested resource for use in connection with the conference session, scheduling information to determine availability of the requested resource proximate in time to the occurrence of the conference session;
determining, based upon the obtained scheduling information for each requested resource of the conference session, whether the requested resource is available to be reserved before or after the occurrence of the conference session; and
displaying one or more status indicators that indicate the availability of the requested resource relative to the occurrence of the conference session.

3. The computer-implemented method of claim 2, wherein obtaining scheduling information further comprises obtaining scheduling information for the requested resource, wherein the requested resource is a conference room, or a piece of conference session related equipment.

4. The computer-implemented method of claim 1, further comprising:
determining that the duration of the conference session may be extended, based on the one or more status indicators that indicate the availability of each participant; and
extending the duration of the conference session.

5. The computer-implemented method of claim 4, further comprising sending updated scheduling information to participants of one or more other meetings that are scheduled to occur after the online conference session, when extending the duration of the conference session.

6. The computer-implemented method of claim 1, wherein obtaining comprises obtaining scheduling information from one or more calendar servers that maintain calendar information for one or more participants.

7. The computer-implemented method of claim 1, further comprising sending a meeting invitation to each of the plurality of participants for the conference session, and wherein obtaining scheduling information comprises obtaining information contained in a response sent to the meeting invitation by a client calendar application.

8. The computer-implemented method of claim 1, wherein the online conference session is scheduled to begin at a start time and end at an end time, and wherein obtaining comprises obtaining scheduling information of each of the participants for time intervals immediately before the start time and immediately after the end time of the conference session.

9. The computer-implemented method of claim 1, wherein displaying comprises displaying a status indicator that indicates the availability of a participant that has not yet joined the conference session.

10. An apparatus comprising:
a network interface unit configured to receive communications over a network;
a processor coupled to the network interface unit, and configured to:
obtain, for each of a plurality of participants of an online conference session, scheduling information proximate in time to or overlapping in time with a scheduled occurrence of the conference session;
determine, based upon the obtained scheduling information for each participant, whether the participant has a scheduled activity prior to, during or after the occurrence of the conference session; and
generate for display in a display window during the conference session, one or more status indicators that indicate the availability of one or more participants of the plurality of participants relative to the occurrence of the conference session.

11. The apparatus of claim 10, wherein the processor is further configured to:
obtain, for a requested resource for use in connection with the conference session, scheduling information to determine availability of the requested resource proximate in time to the occurrence of the conference session;
determine, based upon the obtained scheduling information for each requested resource of the conference session, whether the requested resource is available to be reserved before or after the occurrence of the conference session; and
generate for display one or more status indicators that indicate the availability of the requested resource relative to the occurrence of the conference session.

12. The apparatus of claim 11, wherein the processor is further configured to obtain scheduling information for the requested resource, wherein the requested resource is a conference room or a piece of conference session related equipment.

13. The apparatus of claim 10, wherein the processor is further configured to:
determine that the duration of the conference session may be extended, based on the one or more status indicators that indicate the availability of each participant; and
extend the duration of the conference session.

14. The apparatus of claim 13, wherein the processor is further configured to send updated scheduling information to participants of one or more other meetings that are scheduled to occur after the online conference session, when extending the duration of the conference session.

15. The apparatus of claim 10, wherein the processor is further configured to obtain scheduling information from one or more calendar servers that maintain calendar information for one or more participants.

16. The apparatus of claim 10, wherein the processor is further configured to send a meeting invitation to each of the plurality of participants for the conference session, and obtain information contained in a response sent to the meeting invitation by a client calendar application.

17. The apparatus of claim 10, wherein the online conference session is scheduled to begin at a start time and end at an end time, and wherein the processor is further configured to obtain scheduling information of each of the participants for time intervals immediately before the start time and immediately after the end time of the conference session.

18. The apparatus of claim 10, wherein the processor is further configured to generate for display a status indicator that indicates the availability of a participant that has not yet joined the conference session.

19. One or more computer-readable storage media encoded with software comprising computer executable instructions and when the software is executed operable to:
obtain, for each of a plurality of participants of an online conference session, scheduling information proximate in time to or overlapping in time with a scheduled occurrence of the conference session;
determine, based upon the obtained scheduling information for each participant, whether the participant has a scheduled activity prior to, during or after the occurrence of the conference session; and
generate for display in a display window during the conference session, one or more status indicators that indicate the availability of one or more participants of the plurality of participants relative to the occurrence of the conference session.

20. The computer-readable storage media of claim 19, further comprising instructions operable to:
obtain, for a requested resource for use in connection with the conference session, scheduling information to determine availability of the requested resource proximate in time to the occurrence of the conference session;
determine, based upon the obtained scheduling information for each requested resource of the conference session, whether the requested resource is available to be reserved before or after the occurrence of the conference session; and
generate for display one or more status indicators that indicate the availability of the requested resource relative to the occurrence of the conference session.
